(19) United States
(12) Patent Application Publication
(10) Pub. No.: US 2008/0200364 A1
(43) Pub. Date: Aug. 21, 2008

(54) Coated Peroxycarboxylic Acid Granules, Process For Their Preparation and Their Use in Detergent, Bleach or Disinfection Applications

(75) Inventors: Roberto Garaffa, Milano (IT); Piera Verrocchio, Pescara (IT)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay SA, Brussels (BE)

(21) Appl. No.: 12/065,729

(22) PCT Filed: Sep. 6, 2006
(86) PCT No.: PCT/EP2006/066075

§ 371 Date: Mar. 5, 2008

(30) Foreign Application Priority Data
Sep. 6, 2005 (EP) 05108171.9

(51) Int. Cl. C11D 1/04; B32B 9/00; B05D 1/02

(52) U.S. Cl. 510/488; 428/407; 427/427.7

(57) ABSTRACT

Coated peroxycarboxylic acid granules, process for their preparation and their use in detergent, bleach or disinfection applications Coated peroxycarboxylic acid granules containing at least one coating layer of at least one non-reducing oligomeric saccharide can be prepared by contacting peroxycarboxylic acid granules with at least one coating agent containing at least one non-reducing oligomeric saccharide. These granules can be used in detergent, bleach or disinfection applications.

The present application claims the benefit of the European patent application 05108171.9 filed on Sep. 6, 2005, herein incorporated by reference.

The present invention relates to percarboxylic acid granules, in particular to imido-alkane-percarboxylic acid granules, and to a process for preparing these granules. It also relates to the use of these granules in detergent, bleach and disinfection applications.

Peroxycarboxylic acids have long been known for their ability to perform enhanced bleaching activity at low temperature and particularly in the temperature range of 5 to 35° C., but also at higher temperature for instance of 60° C. or higher. The international application WO 2004/007452 filed by SOLVAY SOLEXIS S.p.A. discloses imido-alkane-percarboxylic acid crystals of a particular crystalline form which can be used in bleach or in disinfection applications.

Sparingly water soluble, crystalline peroxycarboxylic acids are easy to process into dry stable granules suitable for commercial products. For instance, the European patent application EP 852259 assigned to SOLVAY SOLEXIS S.p.A. discloses granular compositions of ε-phtalimido-peroxyhexanoic acid (called PAP).

Some peroxycarboxylic acids are also well known for being environmental friendly and human safe materials for general detergency.

Another advantage of using peroxycarboxylic acids resides in that they can provide high bleaching efficiency without causing colours fading or fibres degradation.

Dry granules containing peroxycarboxylic acids can be mixed with consumer household or Industrial & Institutional cleaning compositions in order to obtain powdered bleaching additives or detergent compositions for laundry as well as bleaching and deodorizing dishwashing compositions. Further applications may be, but not limited to, the hygiene and the disinfection for both the consumer and the Industrial & Institutional sectors.

It is well known that the detergent cleaning compositions must have a prolonged shelf life in order to keep their performance in time.

It is also well known that peroxycarboxylic acids are quite sensitive to the alkalis that are typical of the above cited cleaning compositions. The sensitivity is even more enhanced if such cleaning compositions contain some water dispersed or adsorbed onto its components. The said sensitivity consists in that through the physical contact between peroxycarboxylic acid granules and alkalis, optionally in combination with a wet environment, peroxycarboxylic acid granules may loose their chemical properties, thus resulting in a loss of performance in bleaching, deodorizing or disinfecting action. Also the shelf life of the relevant cleaning compositions will be reduced accordingly.

The aim of the present invention is to prevent the loss of stability of granules of peroxycarboxylic acids due to alkalis and optionally to wet environment of the detergent or cleaning compositions without affecting their ease of dissolution in the application stage.

Consequently, the present invention is related to coated peroxycarboxylic acid granules containing at least one coating layer of at least one non-reducing oligomeric saccharide.

One of the essential characteristics of the present invention is the use of non-reducing oligomeric saccharides for coating (or covering or encapsulating) the peroxycarboxylic acid granules. The Applicant has found that by coating the surface of granules of peroxycarboxylic acids with one or more layers of non-reducing oligomeric saccharides, an increased chemical and shelf stability of the peroxycarboxylic acids is achieved.

By coating the surface of the granules of peroxycarboxylic acids it is meant to apply at least on part of the surface a film or layer of the coating agent, the film or layer being as continuous, homogeneous and uniform as possible.

Without being bound by any theory, it is believed that the effectiveness of coatings obtained in the present invention may be assisted by the ability of solutions or suspensions of the selected non-reducing oligomeric saccharides to spread easily across the surface of the peroxycarboxylic acid granules and thereby create a barrier or layer from even small amounts of coating agent that prevents or reduces interaction between the peroxycarboxylic acid granules and the environment, be it water vapor in the local atmosphere and/or other particulate materials in for example detergent compositions in which the peroxycarboxylic acid granules are incorporated as a bleach.

By oligomeric saccharide it is meant polymers of low molecular weight obtained by condensation of monosaccharide units. The oligomeric saccharide is generally obtained by condensation of from 2 to 9 monosaccharide units. The oligomeric saccharide does not contain any unit different from a monosaccharide. The oligomeric saccharide is therefore different from polyglucosides which are polymers of alkylglucoside units of formula

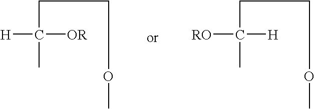

R being an alkyl group containing at least one C atom.

The non-reducing oligomeric saccharide is preferably a disaccharide, and particularly sucrose. It will be recognized that as employed herein, a reference to sucrose includes the molecule itself and any polymeric derivatives that are derivable during processes for applying a coating to peroxycarboxylic acid granules. For example, during some processes for applying a coating, it is normal practice to contact the peroxycarboxylic acid granules with a hot gas, which may encourage polymerisation. For the avoidance of doubt, the derivatives of sucrose, if any, that arise during such coating processes are encompassed within the instant invention.

It will be recognized that the term oligomeric saccharide excludes starch and similar extremely high molecular weight materials.

The sucrose or other non-reducing oligomeric saccharide need not constitute all the coating. Indeed, it is possible for the coating to further comprise at least one co-coating agent. Peroxycarboxylic acids are known for being quite sensitive to the contact with alkalis, for this the co-coating agents have to be selected for being not only non reducing agents of peroxycarboxylic acids, but also non alkaline, or at least adjustable to a range of pH where peroxycarboxylic acids show long term stability and compatibility.

Another key feature of suitable co-coating agents is their ability to be spread along a wide surface in a film as continuous as possible able to provide as much as possible physical separation between the core of the granules, which contains the Peroxycarboxylic acids, and the external environment. This feature is commonly known as film-ability and is in connection with the Theological properties of the coating solutions or suspensions and the crystallinity of the agents when the solvent is removed.

The Applicant has developed a simple method to test the solutions or suspensions containing the coating agents for their film-ability properties.

The solutions that are mentioned herein are aqueous solutions. A weighted sample of each solution is spread and allowed to dry out into a Petri dish at the same temperature of the process that will be used to apply the coating. The resulting film of dry material shall be thin and continuous and shall not show any creeks. The same applies to suspensions.

Further key features of the spraying coating solutions or suspensions are low viscosity, high active content, easiness of preparation and prompt solubility in typical washing conditions. For instance, a 30% solution of sucrose in water gives a clear liquid which shows a very limited viscosity: the optimal viscosity for the coating solution is recognized in a range between 10 and 300 mPa*s and preferably between 20 and 100 mPa*s.

The co-coating agent can be a salt of a carboxylic or organophosphonic acid.

The co-coating agent can be used together with the non-reducing oligomeric saccharide in the same coating step or in an additional distinct coating step. It is a process advantage to avoid the use of additional processing steps, so that it is distinctly desirable to employ a mixture of the coating agents instead of separate additions where more than one agent is used, particularly if the additions occur simultaneously onto an agitated bed of particles.

The co-coating agent is often selected from inorganic salts, preferably alkali metal or alkaline earth metal salts and more preferably an alkali metal sulphate or phosphate. Within the term phosphate, there are encompassed ortho, pyro and metaphosphates or mixtures thereof.

The preferred co-coating agents are Magnesium sulphate, Sodium sulphate, Monosodium Citrate, Monosodium Diphosphate, phosphonates, Sodium Phosphates, amongst the others, or mixtures thereof comply with cited key properties of the relevant solutions. Those materials are selected for enhancing the protection of the peroxycarboxylic acids against the aggressive external environment given by detergent compositions.

Further materials can be selected for the preparation of the coating solution or suspension in order to provide additional features to the coating material, such as good wet ability, chemical stabilization of the peroxycarboxylic acids, pH regulation. The materials which have been considered are: surfactants, chelating agents, antifoaming agents, alkalis. In particular, amongst the others, ethoxylated-oxo-alcohols such as those provided by CLARIANT under the trade name GENAPOL®, sodium secondary-alkan-sulfonates such as those provided by CLARIANT under the trade name HOSTAPUR® SAS, 1,1-hydroxyethyliden diphosphonic acid (HEDP), silicon oils as antifoaming agents such as the product DB100 from DOW CORNING, precipitated silica such as the product SY350 from SYLISIAMONT, polyacrylic acids such as those from ROHM & HAAS, and caustic soda have been respectively selected. The amount of each component may range from 0.01% to 2% of the coating solution.

In many preferred embodiments of the present invention, the coating applied to the peroxycarboxylic acid granules comprises from 5 to 80 parts by weight of a non-reducing oligomeric saccharide, particularly sucrose together with respectively 95 to 20 parts by weight in total of one or more organic or inorganic salts such as those selected from tartrate, citrate, succinate, glutarate, adipate and ascorbate, sulphate or phosphate. In special cases, the coating comprises from 10 to 60 parts by weight of the non-reducing oligomeric saccharide together with 90 to 40 parts by weight of said selected salt(s).

Especially desirable combinations of coating agents according to the present invention comprise from 15 to 50 parts by weight of sucrose in conjunction with 50 to 15 parts by weight of salts such as sulphate, phosphate or citrate.

The organic salts, and especially those of an alkali metal salt such as sodium or magnesium, can be salts of a carboxylic acid or hydroxycarboxylic acid. Suitable examples include tartrate, citrate, succinate, glutarate, adipate and ascorbate, and preferably the sodium, potassium or magnesium salts thereof. Mixtures of such salts can be used, as for example mixtures of succinate, glutarate and adipate.

It is highly desirable to select as co-coating agents those which are readily water soluble in the range of ambient temperature to mildly elevated, such as from about 10° C. to 40° C. or 60° C., which encompasses temperatures usually encountered in cold steeping and low temperature machine washing or hand-washing laundry processes or in cleansing of hard surfaces. Such co-coating agents include alkali metal sulphates, phosphates and low molecular weight carboxylates like citrate, tartrate, adipate or succinate. The choice of a soluble coagent with sucrose or other oligomeric saccharide enables rapid dissolution of the peroxycarboxylic acid in use.

The total quantity of coating agent used, including both non-reducing oligomeric saccharide, particularly sucrose, and any co-coating agents, usually represents 0.5 to 20% w/w of the coated peroxycarboxylic acid. Preferably, the total quantity is selected in the range of from 1 to 15% w/w and in many instances from 2 to 10% of the coated peroxycarboxylic acid. In many practical embodiments, the total weight of coating agent is selected in the range of from 3 to 10%. The weight of sucrose or other non-reducing oligomeric saccharide included in the coated peroxycarboxylic acid is not more than 10 %, is usually selected within the range of from 1 to 8%, in many instances from 1.8 to 6% and in a number of favoured instances in the range of from 3% to 5% with the balance of total coating agents weight being supplied by appropriate amounts of co-coating agent or agents, and in particular inorganic or organic agents such as those indicated herein. The co-coating agent or mixture of them often provides a weight of from 0.5 to 8% of coating based on the weight of the coated material, and in many instances from 1 to 5.5%.

The amount of non-reducing oligomeric saccharides to be applied is determined by achieving an actual increment of the stability of the coated granules of Peroxycarboxylic acids in comparison to the uncoated granules, for example when stored in an hydrostatic oven in controlled atmosphere of 37° C. and 65% of relative humidity, in the presence of a reference cleaning composition.

The Peroxycarboxylic acid is preferably an imido-alkane-percarboxylic acid. It advantageously has the formula (I)

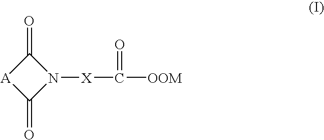

in which A indicates a group chosen from the following:

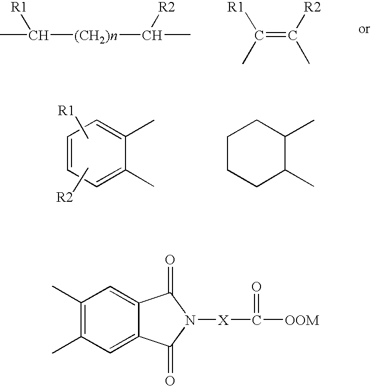

in which:
n is an integer 0, 1 or 2,

R1 has one of the following meanings: hydrogen, chlorine, bromine, C₁-C₂₀ alkyl, C₂-C₂₀ alkenyl, aryl or alkylaryl,

R2 is hydrogen, chlorine, bromine or a group chosen from the following: —SO₃M, —CO₂M, —CO₃M or —OSO₃M,

M means hydrogen, an alkali metal, ammonium or an equivalent of an alkaline-earth metal,

X indicates a C₁-C₁₉ alkylene or an arylene.

The imidoalkanepercarboxylic acid is most preferably ε-phthalimido-peroxy-hexanoic acid (PAP).

The percarboxylic acid can be in the a crystalline form or in the β crystalline form. Percarboxylic acids in the β form are composed of crystals having an average size of generally higher than 100 μm. Examples of such percarboxylic acids in β form are disclosed in the European patent applications EP 556769, EP 560155 and EP 780374. The crystals in β form can also have smaller average sizes (lower than 100 μm) when those of an average size more than 100 μm are milled. Percarboxylic acids in the a form generally have an average size lower than 30 μm and are most often characterized with respect to the β form in that respective spectra obtained by the X Ray Diffraction and the Surface Infrared Spectroscopy (IR/S) techniques show, with respect to those of the β form of the same peracid, a different spectral image at X rays and a typical absorption shift in the 1697-1707 cm-1 zone at IR/S towards higher frequencies of the order of about 8-10 cm-1. Peroxycarboxylic acids in the α form are disclosed in the international application WO 2004/007452, the text of which is incorporated herein by reference. The peroxycarboxylic acids in the α form described therein are particularly suitable.

The granules of percarboxylic acid of the invention have generally, before coating, a mean particle size of at least 200 μm, in particular at least 400 μm, and preferably at least 600 μm. Their mean particle size is usually at most 2000 μm, especially at most 1700 μm, values of at most 900 μm being the most advantageous. Typical values can be for instance 650 μm, 780 μm, 800 μm or 910 μm. The granules can be obtained by any adequate known agglomeration technique. Examples of agglomeration techniques are described in the European patent application EP 852259 or in the pending international application filed as EP 2005/051173 on Mar. 13, 2005, the text of which is incorporated herein by reference. In this application, the peroxycarboxylic acid is present in the granules in the β form which is obtained from the corresponding α form.

The invention is also related to a process for the preparation of the coated peroxycarboxylic acid granules described above, comprising contacting peroxycarboxylic acid granules with at least one coating agent containing at least one non-reducing oligomeric saccharide.

The coating agent or combination of coating agents of the present invention is advantageously employed in the form of an aqueous solution or suspension. Aqueous solutions are preferred.

The preparation of the coating solutions is carried out by mixing the components into water, under heating or at room temperature and allowing all components to completely dissolve. Care must be taken to avoid sucrose to enter into contact with the solution when the pH is lower than 2.5 in order to prevent the hydrolysis of the sucrose. At the end of the mixing each solution is adjusted at a suitable pH, for instance pH of about 3.7 by adding small amounts of diluted caustic soda or diluted sulfuric acid.

In case of a solution, in practice, the concentration of the coating agent, ie the total of the non-reducing oligomeric saccharide and any co-coating agent, in the aqueous coating solution is at least half of and preferably as close as is convenient to, its saturation concentration of the solution at the application temperature. In this way, only a comparatively small and preferably at or near the smallest practicable quantity of water needs to be evaporated subsequently to produce dry peroxycarboxylic acid granules, thereby requiring a lesser or least heat input during the drying stage, but retaining the advantage of applying the coating agent in a solution which can spread across the surface of the peroxycarboxylic acid granules. The concentration of coating agent in the aqueous coating solution is generally at least 15% by weight, preferably at least 20% by weight. Concentrations above or equal to approximately 25% by weight are particularly advantageous and in many instances, the coating agents are sufficiently soluble that solutions containing between 30 and 35% by weight solute in 70 to 65% by weight water can be employed at a solution temperature in the region of 30 to 50 OC. In some combinations, such as with soluble citrate it is possible even to employ coating solutions containing from 55 to 65% by weight coating agent and the balance water (65 to 55%) at such temperatures. It will be recognized that the coating agent solutions contemplated herein remain free flowing at application temperatures, particularly when a mixture of non-reducing oligomeric saccharide and co-coating agent is employed, thereby assisting the peroxycarboxylic acid granules to absorb at least a fraction of the solution during the process of applying the coating agent and to assist in the rate of spreading of the solution across their surfaces.

The dissolution of the coating agent or its constituents can take place conveniently at a temperature of from 15 to 95° C., and preferably from 20 to 70° C.

It will be recognized that it is not necessary for all the coating agent constituents to be dissolved in a single solution, and that each constituent or a sub-combination can be introduced separately, though such separate employment would tend to increase the amount of solution needed per weight unit of coating agent.

It will also be recognized that a slurry of the coating agents can be employed instead of a solution, for example a suspension of particulate inorganic salt in a solution of the non-reducing oligomeric saccharide. This would enable a relatively large weight of coating to be applied in a single pass, but in practice usually requires small particulates of mean size below 100 microns to be processed.

As a general indication, when a coating agent is applied by the same method, the extent to which peroxycarboxylic acid granules stability is ameliorated increases as the thickness of the coat increases, though non-linearly. The selected weight of coating takes into account the manner of coating, the length of the period for which the resultant composition should remain stable, the environment in which the peroxycarboxylic acid granules will be used, such as the temperature and humidity of storage conditions and the proportion of relatively aggressive washing composition constituents like zeolites.

The process according to the present invention by which peroxycarboxylic acid granules are coated with the coating agent described above can comprise any method known for contacting peroxycarboxylic acid granules with coating agent. A preferred means for bringing the coating agent into contact with the peroxycarboxylic acid granules comprises spraying an aqueous solution or suspension, preferably a solution, of the coating agent onto the peroxycarboxylic acid granules. It is particularly desirable for the peroxycarboxylic acid granules to be kept in motion. Thus, a coating process of the present invention can desirably be carried out in a range of apparatuses that can agitate particles, of which practical examples include a fluid bed, a rotating plate, and a rotary mixer into each of which it is convenient to spray the coating agent solution or suspension. During the course of the contact, the peroxycarboxylic acid granules tend to adsorb, and to some extent absorb the coating agent solution or suspension and with simultaneous or subsequent evaporation of the solvent from the coating agent solution or suspension, a coating is deposited around the peroxycarboxylic acid granules.

It will be recognized that the coating process of this invention may be conducted in a single pass through the coating apparatus or in a plurality of passes, at the discretion of the user. A plurality of passes is particularly beneficial for application of a heavy coating in that it reduces the amount of solvent that needs be removed in each pass and thus reduces or removes the risk of over-wetting the peroxycarboxylic acid granules before it is dried. A continuous or batch method can be used.

Contact of the coating agent solution with the peroxycarboxylic acid granules can be carried out at the same time and in the same vessel as evaporation of solvent from the solution or suspension and formation of the coating layer. The two steps can alternatively be carried out separately in different apparatus, which may in some cases be of the same type, eg both in fluidized beds, or be of different types, such as the mixing step in a rotary mixer and the evaporation step in a fluidized bed.

An apparatus such as a fluid bed is particularly suitable for carrying out simultaneous spraying and evaporation. In such an operation, the temperature of the fluid bed is usually maintained in the range of 30 to 65° C. and preferably 35 to 55° C.

One particularly advantageous process variation comprises contacting a charge of the peroxycarboxylic acid granules with a solution of the invention coating agent in a separate mixer, particularly a rotary mixer, and drying the wetted peroxycarboxylic acid granules subsequently in a fluid bed. The solution can be introduced into the mixer by spraying or even via a coarse spray such as one or more nozzles. In this separate mixer variation, the temperature in the mixer is often selected in the range of 10 to 60° C. and preferably 20 to 50° C. The advantage of employing a solution containing sucrose is that it is able to spread readily across the peroxycarboxylic acid granules surfaces within the mixer. Drying in the fluid bed is then often carried out at a temperature of 30 to 65° C. and preferably of from 35 to 55° C.

The fluid bed employed herein either for a combined coating/drying process or simply in the drying stage can be operated in accordance with known procedures for coating/drying or simply drying, as the case may be.

Thus, any non-reactive gas can be used as the fluidizing gas, including air in particular. The gas can be pre-dehumidified, if desired, and pre-heated to maintain the temperature of the fluid bed at the desired value. It is also possible to use direct heating means for the fluidized bed, such as a tube bundle placed within the fluid bed or a heated jacket around the bed. The upward airflow of fluidizing gas is regulated to maintain the peroxycarboxylic acid granules in an agitated state, i.e. not settling, but is not so great as to blow the particles, other than fines, out of the fluidizing vessel.

The aqueous coating solution or suspension and the peroxycarboxylic acid particles are generally brought into contact at a temperature within about 30° C. of each other and preferably within about 10° C. of each other.

The proportions of coating agent solution and peroxycarboxylic acid granules are chosen so as to leave, after drying, the desired weight of coating agent around the peroxycarboxylic acid granules. In practice, it is desirable to limit the addition of solution or suspension to peroxycarboxylic acid granules in a fluid bed or mixer to a maximum water content of about 15% w/w so as to minimize or eliminate wetting out problems, more preferably to an amount selected in the range of about 3 to 12% w/w water and often from about 6 to 12% w/w water. It is normally desirable also to continue drying until the coated peroxycarboxylic acid granules have a moisture content of below about 1% w/w, such as in the region of 0.1 to 0.7% w/w. The duration of the drying stage is usually determined by such practical considerations as, amongst others, the amount of coating agent solution or suspension being applied per unit weight of peroxycarboxylic acid granules, the residual content of moisture that will be tolerated, the temperature and moisture content of the influent fluidizing gas, whether additional heating is employed for the bed and the rate at which the gas flows through the bed. It will accordingly vary from apparatus to apparatus and be capable of control by a skilled person in the art of coating peroxycarboxylic acid granules with the aid of preliminary ranging trials.

In preferred embodiments, the coating represents 2 to 10% by weight of the coated product. This is especially advantageous, in that the benefit of excellent stability is achieved with the application of only a small weight of coating agent.

Furthermore, in at least some of the particularly useful embodiments, the coated peroxycarboxylic acid granules have a mean particle size of from 200 to 2000 μm and preferably of from 400 to 1700 μm, for instance from 600 to 900 μm.

The present invention is also related to the use of the coated peroxycarboxylic acid granules described hereinabove and/or produced by the process according to the present invention hereinabove, in detergent, bleach or disinfection applications. The coated peroxycarboxylic acid granules of the invention can indeed be used in unmodified form or as a mixture with other ingredients, which may be in granular form, and which are typical of detergency products in granular form, powder form, in the form of tablets or liquids. The said coated peroxycarboxylic acid granules or the mixtures thereof, as mentioned above, can be used for the bleaching and disinfecting applications intrinsic to the field of detergency, for both industrial uses and domestic uses. They are particularly suitable for bleaching, especially for removing marks from any type of white or coloured fabric, the characteristics of the fabric that has been subjected to the treatment remaining unchanged. They also constitute a suitable intermediate for preparing disinfectants, which are particularly valued in the detergency market, precisely for the increasing demand to use mild conditions in washing, which is more often performed at low temperature and for short times, which, per se, favour the proliferation of the bacterial load and are harmful to the hygiene. The said disinfectant solutions also find a useful application in the field of the cleaning and sanitization of hard surfaces. The coated peroxycarboxylic acid granules can also be used in compositions for washing dishes.

The present invention also concerns detergent, bleach or disinfection compositions containing the coated peroxycarboxylic acid granules described hereinabove and/or produced by the process according to the present invention hereinabove. These compositions can also contain one or more components chosen from builders, either zeolitic or non-zeolitic (such as phosphate builders), surfactants, anti-redeposition and soil suspension agents, bleaches (such as percarbonate or perborate), bleach activators, optical brightening agents, soil release agents, suds controllers, enzymes, fabric softening agents, perfumes, colours and processing aids.

Certain embodiments of the present invention are described hereinafter in greater detail by way of example only.

### EXAMPLES 1 TO 7

Peroxycarboxylic acid granules have been coated and tested in a bleaching test and in a storage stability test.

Dry granules obtained from Phthalimido peroxy-hexanoic acid in the alpha form (alpha-PAP) available from Solvay Chimica Bussi under the trade name of EURECO® were used as starting material.

Sucrose was used as non-reducing oligomeric saccharide in the examples 3 to 7 according to the invention. In comparative example 1, no coating agent was used and in comparative example 2, sodium sulphate was used as coating agent.

The coating solutions were prepared by mixing the components into water, under heating or at room temperature and allowing all components to completely dissolve. The solutions were prepared at 30° C. Care was taken to avoid sucrose to enter in contact with the solution when the pH was lower than 2.5 in order to avoid the hydrolysis. To this end, at the end of the mixing, each solution was adjusted at a pH of 3.7 by alternatively adding small amounts of diluted caustic soda or diluted sulfuric acid. Table 1 reports the list of the solutions prepared and their compositions.

TABLE 1

| | Coating solution | | | | |
|---|---|---|---|---|---|
| Weight % | CS 1 | CS 2 | CS 3 | CS 4 | CS 5 |
| Sucrose | | 30 | 30 | 30 | 30 |
| MgSO4 | | 30 | | | |
| SAS^{(a)} 30% + DB100^{(b)} | | 1 | 1 | 1 | |
| Monosodium Citrate | | | 30 | | 30 |
| GENAPOL X020^{(d)} + | | | | | 1 |
| DB100 | | | | | |
| NaH₂PO₄ * H₂O | | | | 30 | |
| SILICA | | | | | 2 |
| Anhydrous sodium | 15 | | | | |
| sulfate | | | | | |
| Water | to | to | to | to | to |
| | balance | balance | balance | balance | balance |
| Dry Active matter | 15 | 61 | 61 | 61 | 63 |

^{(a)}secondary alcane sulfonate: product HOSTAPUR ® SAS 30 ex CLARIANT
^{(b)}silicone oil: product DB100 ex DOW CORNING
^{(d)}non-ionic ethoxylated alcohol: product GENAPOL ® X020 ex CLARIANT

Preliminary experiences demonstrated that the fluidized bed technology provides a reliable process and allows to obtain a uniformly covering of the surface of the granules with the selected materials which are sprayed through nozzles. For this reason, the same technique was selected for the production of the samples of the present invention. In particular the Applicant has found that the use of the 15″- or 18″-Wurster (available from Glatt GmbH) is most suitable. Both models can be used for the production of small or medium size samples.

The coating process consisted in a series of sequential operations where a suitable amount of granules based on Peroxycarboxylic acids were loaded in the fluidizing chamber: typically this amount was 10 kg for the 15″ Wurster or 45 kg for the 18″ Wurster; then through a controlled air stream, the granules were fluidized and heated at a temperature which is generally chosen from 35° C. and 65° C. or preferably from 37° C. and 45° C. In the tests, the temperature was 40° C. The flow of the air stream was regulated in order to generate the turbulence required by the process itself. Subsequently, when the suspended granules had reached the setup temperature, the coating solution was sprayed through the nozzle. The spraying rate was controlled in order to avoid over-wetting, clogging or over-heating of the granules. During the process the water was evaporated leaving a dry solid layer on the surface of the granules. The process was designed in order to keep the temperature of the granules controlled in a range of temperature as setup in the heating stage. The thickness of the coating layer was defined by the spraying time of the solution on the granules. Along the process some step adjustments of the air flow were necessary in order to keep a suitable fluidization of the granules and to take into account the increase of weight of the granules due to the addition of the coating layer. At the end of the spraying stage, the coated granules were allowed to cool down by reducing the temperature of the air stream down to 25° C. Afterwards the material was unloaded into a suitable plastic container.

The coating trials are summarized in table 2.

TABLE 2

| | Coating | Coating | Composition of the | |
|---|---|---|---|---|
| Trial ID. | Solution | Level, % | coated product, % | |
| Comparative | none | 0 | EURECO ® per-granules | 100 |
| example 1 | | | | |
| Comparative | CS 1 | 10 | EURECO ® per-granules | 90 |
| example 2 | | | | |
| | | | Na₂SO₄ | 10 |
| Example 3 | CS 2 | 3.66 | EURECO ® per-granules | 96.34 |
| | | | Sucrose | 1.80 |
| | | | MgSO₄ | 1.80 |
| | | | SAS 30% + DB100 | 0.06 |
| Example 4 | CS 3 | 3.66 | EURECO ® per-granules | 96.34 |
| | | | Sucrose | 1.80 |
| | | | Monosodium Citrate | 1.80 |
| | | | SAS 30% + DB100 | 0.06 |
| Example 5 | CS 3 | 7.02 | EURECO ® per-granules | 92.98 |
| | | | Sucrose | 3.45 |
| | | | Monosodium Citrate | 3.46 |
| | | | SAS 30% + DB100 | 0.12 |
| Example 6 | CS 4 | 3.66 | EURECO ® per-granules | 96.34 |
| | | | Sucrose | 1.80 |
| | | | NaH₂PO₄ * H₂O | 1.80 |
| | | | SAS 30% + DB100 | 0.06 |
| Example 7 | CS 5 | 10 | EURECO ® per-granules | 90.00 |
| | | | Sucrose | 4.76 |
| | | | Monosodium Citrate | 4.76 |
| | | | GENAPOL X080 | 0.16 |
| | | | SILICA | 0.32 |

The coated products thus obtained were tested in a bleaching test and in a storage stability test.

In each of these tests, the PAP titre was determined by iodometric titration with sodium thiosulfate of the iodine that is released from the reaction of potassium iodide with the peracid that is present in the granules, according to the following method. An accurately weighed amount of some 500 mg of the product to be analysed was diluted in 100 ml of water; 10 ml of glacial acetic acid and 30 ml of aqueous 10% w/w potassium iodide solution were then added. The iodine produced from the reaction was titrated with an aqueous sodium thiosulfate solution of known titre, using a Mettler® DL 40 potentiometric titrator equipped with a platinum electrode and a reference electrode. When the analysis was performed on the samples coming from the storage stability tests (blends), each sample was quantitatively transferred from the capsule to the titrating flask where the blend was diluted in 100 ml of water, 10 ml of glacial acetic acid, 50 ml of phosphoric acid (85%) and 30 ml of aqueous 10% w/w potassium iodide solution. The flask was strongly agitated during the transfer of the blend to allow an immediate neutralization of all alkalis. The titration was then performed the same way as above described.

The bleaching test was performed by adding 1000 mg of coated granules (granulometric fraction from 0.25 mm to 1.40 mm) to one litre of 2% sodium carbonate solution coloured with 0.035% of eriochrome T black, leaving the mixture to stand (without stirring) at 20° C. for five minutes. The result was positive if the dispersion discoloured. The results are shown in table 3.

The storage stability of the coated products was tested in three general methods (methods A, B and C). For each sample a series of 3 tests was carried out according to each method. The results are shown in table 3. The meaning of the result given in table 3 (a number from 1 to 6) is explained in table 4.

### Method A.

50 parts by weight of coated PAP granules were blended with 50 parts by weight of a detergent builder, Zeolite 4A powder obtained from Aldrich, to give an even distribution. The available oxygen (Avox) of the blend was measured. The blend was then stored in an open beaker housed in a constant environment chamber at 37° C. and 65% of relative humidity. Samples were taken after 4 weeks of storage and analyzed for residual Avox. A comparison of the Avox before and after storage gives a measure of the stability of the product.

### Method B.

15 parts of by weight of coated PAP granules were blended with 85 parts by weight of respectively a standard detergent composition, i.e. the IEC detergent type A*, without phosphates and without bleach. The Avox of the blend was measured. A number of 5 g samples of the blend were then stored in closed plastic capsules at a constant temperature of 40° C. for 4 weeks. The difference between the starting Avox and the Avox measured after each week was measured and recorded.

### Method C.

Same as Method B but using a commercial powdered detergent without bleach.

TABLE 3

| | | Coating | | |
|---|---|---|---|---|
| | Coating | Level, | Evaluation | |
| Example | Solution | % | Test | Result |
| Comparative | No coating | 0 | Stability test-Method A | 3 |
| example 1 | | | | |
| | | | Stability test-Method B | 1 |
| | | | Stability test-Method C | 2 |
| | | | Bleaching test | Positive |
| Comparative | CS 1 | 10 | Stability test-Method A | 3 |
| example 2 | | | | |
| | | | Stability test-Method B | 2 |
| | | | Stability test-Method C | 3 |
| | | | Bleaching test | Positive |
| Example 3 | CS 2 | 3.66 | Stability test-Method A | 3 |
| | | | Stability test-Method B | 3 |
| | | | Stability test-Method C | 3 |
| | | | Bleaching test | Positive |
| Example 4 | CS 3 | 3.66 | Stability test-Method A | 5 |
| | | | Stability test-Method B | 3 |
| | | | Stability test-Method C | 4 |
| | | | Bleaching test | Positive |
| Example 6 | CS 4 | 3.66 | Stability test-Method A | 4 |
| | | | Stability test-Method B | 4 |
| | | | Stability test-Method C | 5 |
| | | | Bleaching test | Positive |
| Example 5 | CS 3 | 7.02 | Stability test-Method A | 5 |
| | | | Stability test-Method B | 5 |
| | | | Stability test-Method C | 6 |
| | | | Bleaching test | Positive |
| Example 7 | CS 5 | 10 | Stability test-Method A | 6 |
| | | | Stability test-Method B | 5 |
| | | | Stability test-Method C | 6 |
| | | | Bleaching test | Positive |

In table 4 a ranking criterion is defined in order to get to a homogeneous classification of the samples with respect to the loss of active PAP in each method.

TABLE 4
Stability test ranking

| | | | Method B | | |
|---|---|---|---|---|---|
| Method A | Rank | PAP loss % | or C | rank | PAP loss % |
| | 1 | ≧20 | | 1 | ≧50 |
| | 2 | 10-20 | | 2 | 40-50 |
| | 3 | 5-10 | | 3 | 30-40 |
| | 4 | 2-5 | | 4 | 20-30 |
| | 5 | 1-2 | | 5 | 10-20 |
| | 6 | ≦1 | | 6 | 5-10 |
| | | | | 7 | ≦5 |

1. Coated peroxycarboxylic acid granules containing at least one coating layer of at least one non-reducing oligomeric saccharide.

2. The coated peroxycarboxylic acid granules according to claim 1, wherein the peroxycarboxylic acid is an imido-alkane-percarboxylic acid.

3. The coated peroxycarboxylic acid granules according to claim 2, wherein the imido-alkane-percarboxylic acid is ε-phtalimido-peroxy-hexanoic acid.

4. The coated peroxycarboxylic acid granules according to claim 2 wherein the imido-alkane-percarboxylic acid is in the a crystalline form.

5. The coated peroxycarboxylic acid granules according to claim 2 wherein the ε-phtalimido-peroxy-liexanoic acid is in the β crystalline form which is obtained from the corresponding α form.

6. The coated peroxycarboxylic acid granules according to claim 1, wherein the non-reducing oligomeric saccharide is sucrose.

7. The coated peroxycarboxylic acid granules according to claim 1 wherein the coating layer represents from 0.5 to 20% by weight based on the weight of the coated granules.

8. A process for the preparation of the coated peroxycarboxylic acid granules of claim 7 comprising contacting peroxycarboxylic acid granules with at least one coating agent containing at least one non-reducing oligomeric saccharide.

9. The process according to claim 8, wherein the contacting is carried out in a fluidized bed by spraying a solution or suspension of at least one oligomeric saccharide onto the peroxycarboxylic acid granules.

10. A method of use of the coated peroxycarboxylic acid granules of claim 1 in detergent, bleach or disinfection applications.

11. Detergent, bleach or disinfection compositions containing the coated petoxycarboxylic acid granules of claim 1.
